(19) United States
(12) Patent Application Publication
(10) Pub. No.: US 2013/0294445 A1
(43) Pub. Date: Nov. 7, 2013

(54) FLEXIBLE CHANNEL BONDING

(71) Applicant: Rockstar Consortium US LP, Plano, TX (US)

(72) Inventor: Colin Chase, Stittsville (CA)

(21) Appl. No.: 13/932,602

(22) Filed: Jul. 1, 2013

Related U.S. Application Data
(63) Continuation of application No. 10/698,525, filed on Nov. 3, 2003, now abandoned.

(51) Int. Cl. H04Q 11/04

(52) U.S. Cl. CPC H04Q 11/0421
USPC 370/357

(57) ABSTRACT

The bonding of serial channels to form link bundles is accomplished through the organization of the data to be transferred over the link bundles into superframes of data. Transceivers may be dynamically configured responsive to the recognition of a service of input/output card to be serviced, to act as master or slave in channel bonding situations. Multiple link bundles may be supported, thereby allowing for redundant link bundles. The superframes also provide fields for clock correction sequences, cyclic redundancy checks and specification of an active link bundle in contrast to a redundant link bundle.

### FIELD OF THE INVENTION

The present invention relates to processing of high speed data and, more particularly, to flexible channel bonding.

### BACKGROUND

Although serial data rates continue to increase for communication between distant communication endpoints, more significant gains have been made in speed of communication between proximate communication endpoints, for instance, between cards within an element of a communications network.

Such an element may include a number of specific purpose communication circuits. The communication circuits may include input/output cards (IOCs) that are specific to the communications protocol used in the external links to which the IOCs connect. Within the network element, the IOCs often connect to a further communication circuit such as a datapath services card (DSC) which may act to provide, among other services, network processing services to data streams passing through the DSC.

In the movement towards faster short-distance data transfer, parallel data transfer schemes are largely being abandoned in favor of high-speed serial schemes. Some high-speed serial schemes eliminate a need for a separate clock by incorporating clock and data recovery circuitry within a receiver and arranging the data such that the clock may be properly recovered from the data. Use of Low-Voltage Differential Signaling (LVDS) keeps power dissipation low and has additional benefits including low electromagnetic interference generation.

As fast as these serial schemes are, it has been recognized that even higher data transfer rates may be realized by aggregating multiple serial channels. Such aggregation is known as “channel bonding” or “multi-channel alignment”. Channel bonding is a technique wherein several serial channels are considered to be bonded together to create one aggregate channel. A single parallel bus feeds several channels on a transmit side and the identical parallel bus is reproduced on the receive side.

Thus far, however, the only implementation known to the applicant of such channel bonding is the bonding of four SERDES channels (e.g., “Rocket I/O™” channels) to form a single 10 Gigabit Attachment Unit Interface (XAUI). A standard channel bonding sequence is inserted into the data of a 10 Gbit/s serial data stream prior to transmitting the data over four 2.5 Gbit/s channels. The channel bonding sequence is used at the receiving end to align the channels and recreate the 10 Gbit/s serial data stream. However, the data rate provided by the XAUI solution is fixed at 10 Gbit/s. Furthermore, the data sent over the four channels does not include additional data such as control data or flow control data, nor is there an availability to send such additional data. Additionally, no methods are provided for differing clocks, changing transceivers or providing redundant paths to allow for protection switching.

Clearly, a need exists for a flexible method of bonding multiple high-speed serial channels to form even higher speed logical links.

### SUMMARY

The receipt of an indication of the connection of a communication circuit and the class of service required by the communication circuit causes a dynamic configuration of transceivers at a further communication circuit. The configuration of the transceivers allows a flexible implementation of the channel bonding feature of known communication circuits. Once configured, the channel received by a given transceiver may be considered alone or in combination with channels received by at least one other transceiver, where such reception may be followed by bonding of the received channels to form an active link bundle (logical link). In one aspect, channels received by an identical number of redundant transceivers are bonded to form a spare link bundle that carries the same payload as the active link bundle.

Advantageously, use of such link bundles may allow alignment and synchronization to be maintained across a multi-path backplane. Further, allowances are made for alignment between links that follow redundant paired paths, e.g., over spared equipment. Further, when appropriately configured, hitless change-over between these paired paths may be supported.

In accordance with an aspect of the present invention there is provided a method of preparing a first communication circuit for communication with a second communication circuit, where the first communication circuit includes a plurality of transceivers. The method includes receiving an indication of a class of service required by the second communication circuit, determining a number of transceivers necessary to provide the class of service, selecting the number of transceivers to form a subset of selected transceivers from the plurality of transceivers and configuring an attribute of a given transceiver among the subset of selected transceivers. A computer readable medium is also provided such that a processor in the first communication circuit may carry out this method.

In accordance with an aspect of the present invention there is provided a first communications circuit including a plurality of transceivers and a processor. The processor is adapted to receive an indication of a class of service required by a second communication circuit to be connected to the first communication circuit, determine a number of transceivers necessary to provide the class of service, select the number of transceivers to form a subset of selected transceivers from the plurality of transceivers and configure an attribute of a given transceiver among the subset of selected transceivers.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a standard switch architecture including multiple switching modules interconnected through a switching fabric;

FIG. 2 illustrates a structure for an exemplary switching module of the switch of FIG. 1 including input/output cards, cross point switches and a datapath services card;

FIG. 3 illustrates a structure for one of the input/output cards of the switch module of FIG. 2;

FIG. 4 illustrates a structure for an input/output card manager for use in the datapath services card in the switch module of FIG. 2;

FIG. 5 illustrates a structure for a multi-gigabit transceiver for use in the input/output card manager field programmable gate array of FIG. 4;

FIG. 6 illustrates a first configuration for connection of channel bonding ports according to an embodiment of the present invention;

FIG. 7 illustrates a second configuration for connection of channel bonding ports according to an embodiment of the present invention;

FIG. 8 illustrates an exemplary format for a superframe in accordance with an embodiment of the present invention;

FIG. 9 illustrates an exemplary format for a superframe header as part of the superframe of FIG. 8;

FIG. 10 illustrates a structure for a 16 transceiver input/output card manager as an extension of the four transceiver structure of FIG. 4;

FIG. 11 illustrates the switching module of FIG. 2 with the addition of a second input/output card;

FIG. 12 illustrates an exemplary superframe for use when channel bonding a single channel according to an embodiment of the present invention;

FIG. 13A illustrates a first exemplary superframe for use when channel bonding two channels according to an embodiment of the present invention;

FIG. 13B illustrates a second exemplary superframe for use when channel bonding two channels according to an embodiment of the present invention;

FIG. 14A illustrates a first exemplary superframe for use when channel bonding N channels according to an embodiment of the present invention;

FIG. 14B illustrates a second exemplary superframe for use when channel bonding N channels according to an embodiment of the present invention; and

FIG. 14C illustrates a Nth exemplary superframe for use when channel bonding N channels according to an embodiment of the present invention.

### DETAILED DESCRIPTION

OSI is an acronym representative of a commonly-referenced multi-layered communication model, where the letters OSI are the initials of Open Systems Interconnection. Of interest herein are the Physical layer (layer 1) and the Data Link layer (layer 2) of the OSI model.

The Physical layer is used to provide transmission of unstructured bits across a physical medium. Tasks performed on the Physical layer include ordering of bits and bit level error-checking. Probably the best known Physical layer protocol is SONET (Synchronous Optical NETwork).

The Physical layer includes two sublayers, namely, the Physical Media Dependent sublayer (PMD) and the Physical Coding Sublayer (PCS). The PMD is the part of the Physical layer that dictates the way bits are converted to physical signals, such as light in the case of optical fiber. The PCS is the part of the Physical layer that dictates the bit patterns sent to the PMD.

The Data Link layer (often just “link layer”) is used to provide reliable transfer of information across a physical link. Tasks performed on the Data Link layer include synchronization, error control and flow control. Known Data Link layer protocols include the Asynchronous Transfer Mode (ATM), Frame Relay and Ethernet protocols.

In general, to be sent on a link in a local area network or a wide area network, the payload of an Internet Protocol (IP) packet (i.e., an IP datagram) is encapsulated with a header and trailer for the Data Link layer technology of the outgoing physical interface. For example, if an IP datagram is to be sent on an Ethernet interface, the IP datagram is encapsulated with an Ethernet header and trailer.

Close scrutiny is appropriately paid to the data on the various layers when designing the structure of network elements such as switches.

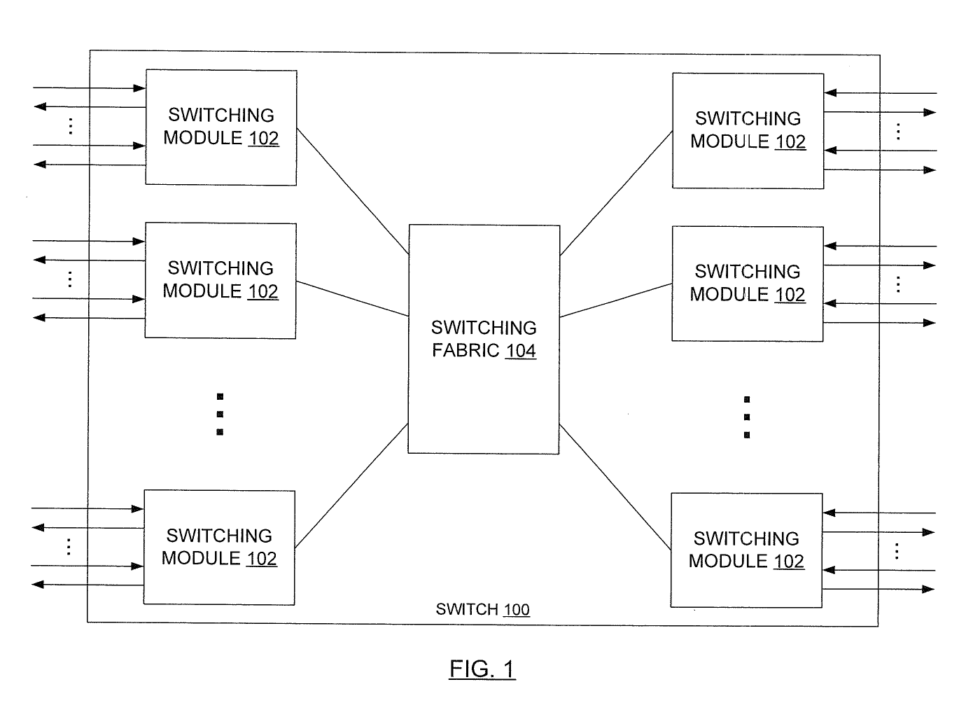

An architecture for a standard switch 100 is illustrated in FIG. 1. The switch 100 includes multiple switching modules 102 interconnected through a switching fabric 104. In addition to maintaining a bi-directional connection with the switching fabric 104, the switching modules 102 also maintain bi-directional connections with data traffic sources and sinks (not shown).

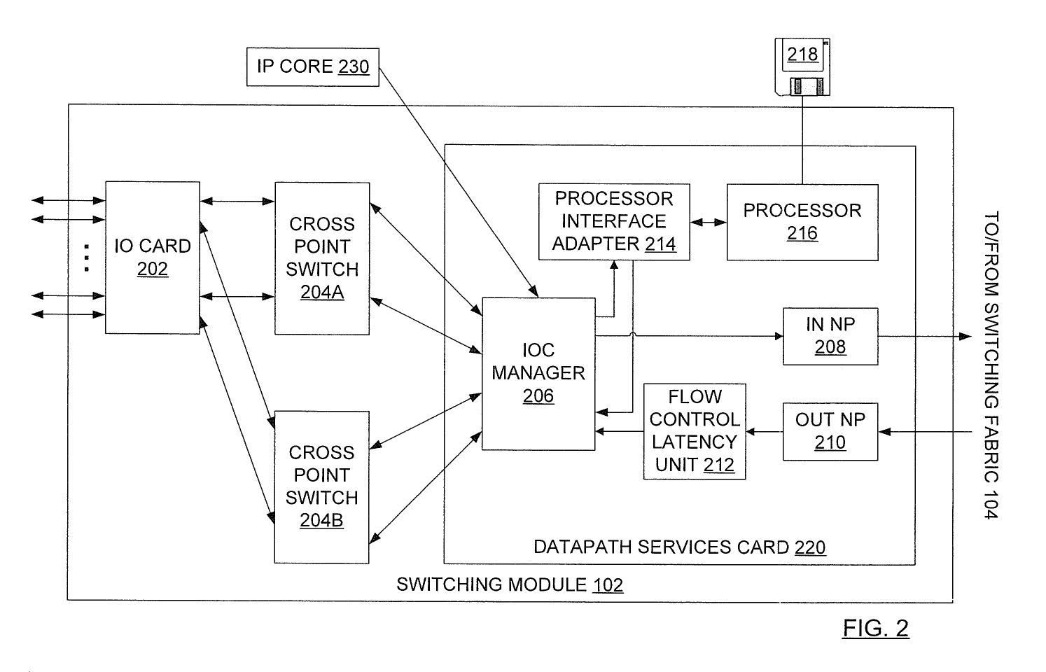

FIG. 2 illustrates a structure for an exemplary switching module 102 of the switch 100 of FIG. 1. The exemplary switching module 102 includes an input/output card (IOC) 202 adapted to terminate and originate connections with data sources and sinks. The IOC 202 may connect to a datapath services card (DSC) 220 via a first analog cross point switch 204A and a second analog cross point switch 204B (individually or collectively 204). In particular, the channels connecting the IOC 202 to the DSC 220 via the cross point switches 204 may be channels operating at 3.125 Gbit/s. However, where the data transmitted over a given channel is encoded, say, using the known 8B10B encoding scheme, the actual data throughput of the channels is 2.5 Gbit/s. The DSC 220 connects the switching module 102 to the switching fabric 104 (FIG. 1).

The cross point switches 204 may be seen to form a “backplane” for the switching module 102. As such, the cross point switches 204 allow the attachment and detachment of the IOC 202 (and other IOCs) to the DSC 220.

The IOC 202 connects to an IOC manager 206 within the DSC 220. The IOC manager 206 may be implemented as a field programmable gate array (FPGA) and, more particularly, the applicant has had success with the Virtex II Pro XC2VP70-6FF1517C FPGA from Xilinx Inc. of San Jose, Calif.

Notably, an FPGA is an integrated circuit (IC) that can be programmed in the field after manufacture. A FPGA typically includes many components expected to be useful to the task to which the FPGA is directed. For instance, components like memory devices, devices for high speed input and output, digital signal processing devices, microprocessors and clock management devices may advantageously be pre-existing on a given FPGA.

As should be clear to a person of ordinary skill in the art, an intellectual property (IP) core is a block of logic or data that is used in adapting (e.g., programming) an FPGA for a specific use. As essential elements of design reuse, IP cores are part of the growing electronic design automation industry trend towards repeated use of previously designed components. Ideally, an IP core should be entirely portable—that is, able to easily be inserted into any vendor technology or design methodology. FIG. 2 illustrates a software medium 230 for loading the IOC manager 206 with a manager IP core.

The IOC manager 206 may send data received from the IOC 202 to an “in” network processor (NP) 208 via an “SPI-3” port. SPI-3 refers to the System Packet Interface Level 3 (SPI-3), which is described in a document titled “OC-48 System Interface for Physical and Link Layer Devices”, June 2000 (see www.oiforum.com/public/documents/OIF-SPI3-01.0.pdf). The in network processor 208 forwards the data, after some processing, to the switching fabric 104 (FIG. 1). The applicant has implemented the in network processor 208 with Multiservice Network Processor APP550 from Agere Systems Inc. of Allentown, Pa.

Alternatively, the interface between the IOC manager 206 and the network processors 208, 210 may be the System Packet Interface Level 4 (SPI-4), which is described in a document titled “OC-192 System Interface for Physical and Link Layer Devices”, January 2001 (see www.oiforum.com/public/documents/OIF-SPI4-02.0.pdf). The use of SPI-4 is especially important for implementation of aspects of the present invention to the handling of SONET OC192 class data streams. Furthermore, it should be noted that the handling of OC192 class data streams will also require capabilities of a network processor beyond those available from the Multiservice Network Processor APP550 mentioned hereinbefore.

On the return path from the switching fabric 104, data is received by an “out” network processor 210. The Agere Systems Multiservice Network Processor APP550 may also be used for the out network processor 210. The output of the out network processor 210 may pass through a flow control latency unit 212 on the way to the IOC manager 206. The flow control latency unit 212 may be implemented as a Xilinx Virtex II Pro XC2VP7-6FF896C FPGA and may act to clean up some flow control latency issues. Communication between the out network processor 210 and the flow control latency unit 212 as well as between the flow control latency unit 212 and the IOC manager 206 may occur over links adhering to the SPI-3 protocol.

The DSC 220 includes a processor 216 for configuring aspects of operation of the IOC manager 206 and the IOC 202. To facilitate control messaging from the processor 216 to the IOC manager 206 and the IOC 202 and back, a processor interface adapter 214 within the DSC 220 connects to the IOC manager 206. The processor interface adapter 214 may, for instance, provide a control interface to allow access to the registers, memories and interrupt events on the IOC manager 206 and devices on the IOC 202.

A computer readable medium 218 is illustrated for loading the processor 216 with processor-executable instructions for carrying out methods exemplary of the present invention. The computer readable medium 218 could be a disk, a tape, a chip or a random access memory containing a file downloaded from a remote source.

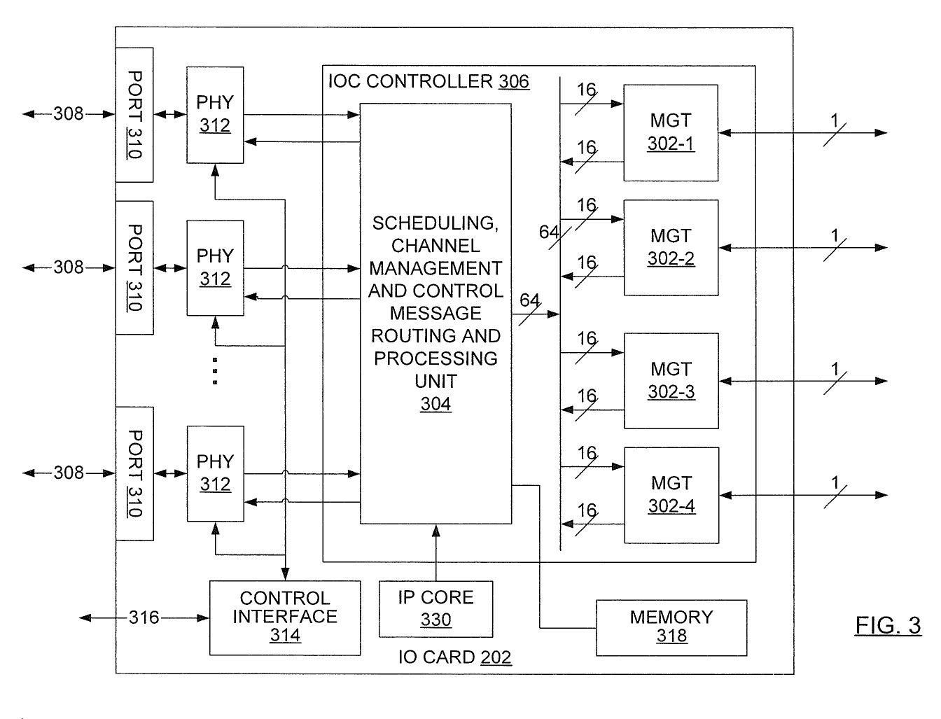

The IOC 202 of the switch module 106 of FIG. 2 is illustrated in further detail in FIG. 3. The IOC 202 is shown to include an IOC controller 306 that, like the IOC manager 206 in the DSC 220, may be implemented as an FPGA. In particular, the applicant has had success with the XC2VP20-6FF896C FPGA from Xilinx Inc. The controller 306 has many datapath interface possibilities. As such, the IOC 202 may include multiple physical ports 310 for transmitting and receiving data over physical lines 308. Additionally, PHY devices 312 handle the physical ports 310, where the datapath types available to the IOC 202 depend on the type of PHY devices that are used on the IOC 202.

The IOC controller 306 includes a first controller Multi Gigabit Transceiver (MGT) 302-1, a second controller MGT 302-2, a third controller MGT 302-3 and a fourth controller MGT 302-4 (individually or collectively 302) for high speed data input/output. The controller MGTs 302 are controlled by and connected to a Scheduling, Channel Management And Control Message Routing And Processing (SCMCMRP) unit 304. As will be appreciated by a person skilled in the art, the SCMCMRP unit 304 is representative of many components of the IOC controller 306 whose detail is beyond the scope of this application. However, it should be noted that the components of the SCMCMRP unit 304 often include a microprocessor and, in the case of the Xilinx FPGAs on which aspects of the present invention have been implemented, the microprocessor is an IBM PowerPC microprocessor. The SCMCMRP unit 304 connects to the controller MGTs 302 over a bus whose width is determined by the number of controller MGTs 302. A 16-bit wide bus connects to each of the controller MGTs 302. Accordingly, where there are four controller MGTs 302 (as shown in FIG. 3), the bus connecting the SCMCMRP unit 304 to the controller MGTs 302 is 64 bits wide.

It has been stated hereinbefore that a well known Physical layer protocol is SONET. As such, it is considered that the PHY devices 312 may terminate SONET traffic. Known classes of SONET traffic (with respective data rates) include OC3 (155 Mbit/s), OC12 (622 Mbit/s), OC48 (2.075 Gbit/s) and OC192 (8.3 Gbit/s). Herein, a given IOC card is referred to by the class of service required to serve the given IOC at the DSC. It should be clear that the IOC cards need not carry the specifically mentioned class of SONET traffic, or even SONET traffic at all. For instance, an OC48 card may connect to four OC12 lines or multiple Gigabit Ethernet lines.

Notably, the four transceiver design of the IOC controller 306 of FIG. 3 is merely exemplary and is specific to an application of aspects of the present invention to the processing of OC48 class traffic. The correspondence of number of transceivers in a given IOC controller to the class of traffic handled by the IOC should become clearer hereinafter.

FIG. 3 illustrates a software medium 330 for loading the IOC controller 306 with a controller IP core.

The IOC controller 306 may also have many control interfaces (e.g., for a Peripheral Component Interconnect interface, commonly known as “PCI”, etc.) adapted to configure and monitor the PHY devices 312. An exemplary control interface 314 is illustrated in FIG. 3 connected to the PHY devices 312 and to a control line 316. As will be appreciated by those skilled in the art, most vendors of PHY devices do not use PC-like interfaces (such as PCI mentioned hereinbefore), but have their own specific interface. It is necessary in implementation, then, to adapt control message requests to the interface specifics of the PHY devices 312.

The IOC controller 306 may also require external RAM (illustrated as a memory 318) to buffer data as the data passes through the IOC controller 306.

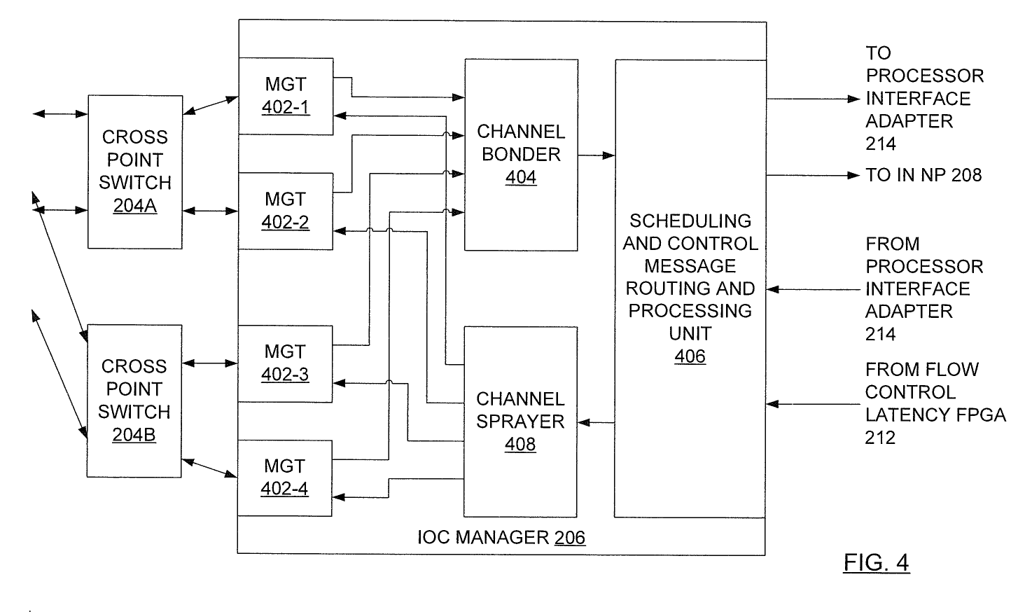

FIG. 4 illustrates a structure for the IOC manager 206. To connect to the IOC 202, the IOC manager 206 includes a first manager MGT 402-1, a second manager MGT 402-2, a third manager MGT 402-3 and a fourth manager MGT 402-3 (individually or collectively 402). The manager MGTs 402 connect, on ingress, to a channel bonder 404 and, on egress, to a channel sprayer 408. The channel bonder 404 and the channel sprayer 408 are each connected to a Scheduling and Control Message Routing and Processing (SCMRP) Unit 406, which connects the IOC manager 206 to the network processors 208, 210 and the processor interface adapter 214.

As mentioned hereinbefore in conjunction with the description of the IOC controller 306, the four transceiver design of the IOC manager 206 of FIG. 4 is merely exemplary and is specific to an application of aspects of the present invention to the processing of OC48 class traffic. The correspondence of number of transceivers in a given IOC manager to a number of IOCs and the class of traffic handled by the IOCs should become clearer hereinafter.

The attachment of a particular controller MGT 302 to a particular manager MGT 402 can be configured in the cross point switches 204 and, consequently, can be changed over time to suit changing needs.

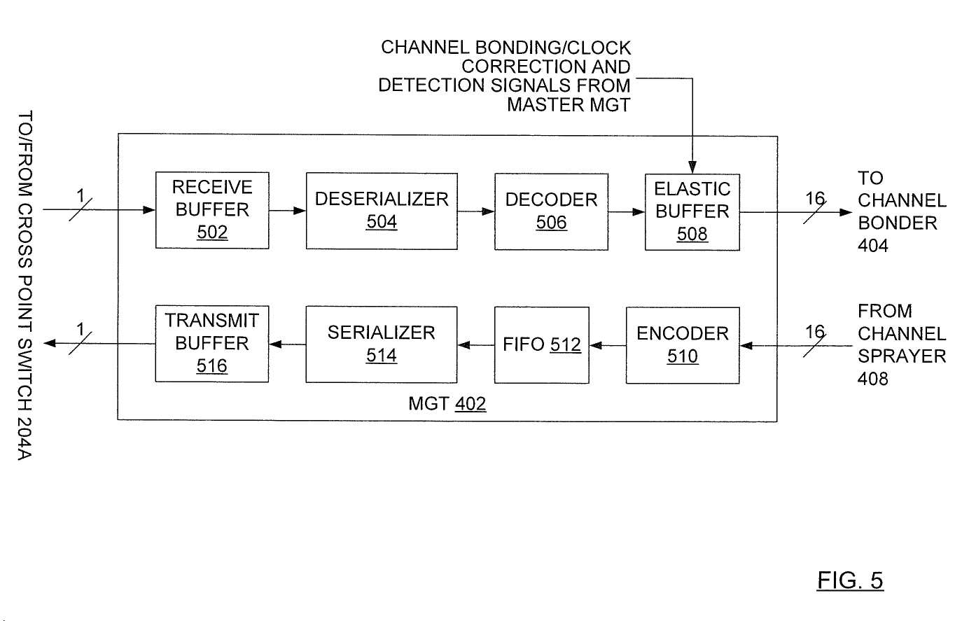

An exemplary structure for one of the manager MGTs 402 used in the IOC manager 206 of FIG. 4 is illustrated in FIG. 5. A receive buffer 502 acts to receive serial data, which is then passed to a deserializer 504. Parallel data is then decoded at a decoder 506 before being passed to an elastic buffer 508 for sending on the channel bonder 404 with timing dictated by channel bonding/clock correction and detection signals received from a MASTER MGT, to be described in greater detail hereinafter.

In the return path, parallel data received from the channel sprayer is encoded by an encoder 510 and buffered briefly in a first-in-first-out (FIFO) buffer 512 before being serialized in a serializer 514. The output of the serializer 514 is received by a transmit buffer 516 on the way to the IOC 202.

Notably, the MGTs 302 of the IOC controller 206 may be structured similarly to the exemplary manager MGT 402 of FIG. 5.

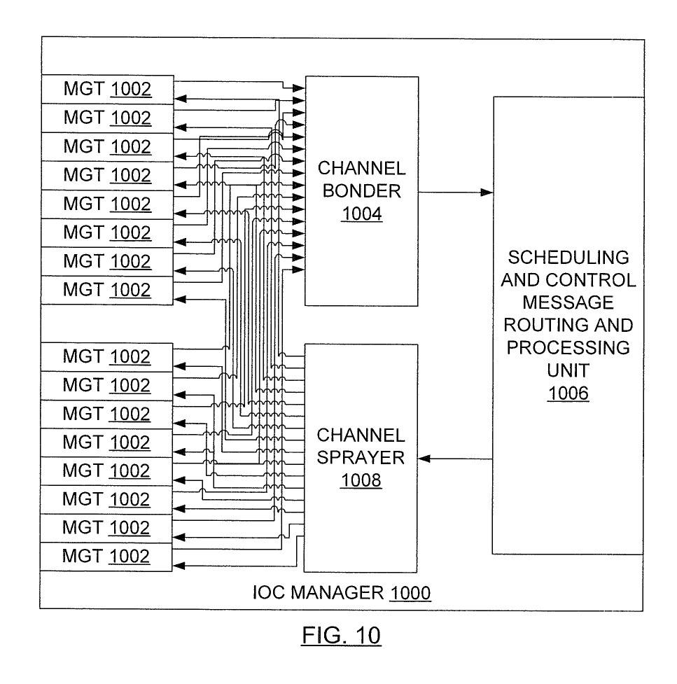

FIG. 10 illustrates a structure for a 16 transceiver IOC manager 1000 as an extension of the four transceiver structure of FIG. 4. As the name suggests, the 16 transceiver IOC manager 1000 includes 16 manager MGTs 1002.

The manager MGTs 1002 connect to a channel bonder 1004 on an ingress path and to a channel sprayer 1008 on an egress path. The channel bonder 1004 and channel sprayer 1008 transmit to and receive from a SCMRP unit 1006, respectively.

A known channel bonding operation requires the insertion of a channel bonding sequence into the serial data sent over each of the serial channels to be bonded. Such a channel bonding sequence may, for instance, be comprised of one or two sequences of length of up to four bytes each. The channel bonding sequence may define a length for itself and include other control information, such as an indication of the designation (described hereinafter) of the channel bonding mode of the MGT sending the channel bonding sequence. At the receiving end, the channel bonding sequence serves to assist in the alignment of the data received over the bonded channels.

As currently implemented, channel bonding requires that one MGT be designated to be in a “MASTER” channel bonding mode. Other MGTs may then be designated to either be in a SLAVE_1_HOP channel bonding mode or a SLAVE_2_HOPS channel bonding mode. The MGTs include input and output bonding control ports. Through such bonding control ports a MASTER MGT may communicate, via an output bonding control port, with the input bonding control port of a SLAVE_1_HOP MGT and a SLAVE_1_HOP MGT may communicate, via an output bonding control ports with the input bonding control port of a SLAVE_2_HOPS MGT. Notably, the input bonding control port of a MASTER MGT is not used, nor is the output bonding control port of a SLAVE_2_HOPS MGT used.

A MASTER MGT at the receive end of a bonded channel may provide, at an output bonding control port, information to the input bonding control port(s) of the SLAVE MGT(s) such as an indication of point at which the MASTER MGT has recognized the arrival of the channel bonding sequence in the elastic buffer 508 (FIG. 5) of the MASTER MGT. With such information, the SLAVE MGT(s) can align themselves to the same point when they see the corresponding channel bonding sequence. Additionally, the MASTER MGT may provide an indication of the point at which the MASTER MGT has recognized the arrival of a clock correction sequence in the elastic buffer 508 (FIG. 5) of the MASTER MGT along with an indication as to what clock corrections, if any, were performed. With such information, the SLAVE MGT(s) can mirror these corrections so that the SLAVE MGT(s) do not become out of step with the MASTER MGT.

In the MGTs of the herein-referenced Xilinx FPGAs (and other manufacturer's FPGAs), the bonding control ports are designed to be directly connected. As such, designation of channel bonding mode for each MGT (i.e., MASTER, SLAVE_1_HOP, SLAVE_2_HOPS) is made prior to device configuration (i.e., prior to the downloaded of software to control the FPGA). That is, the MASTER MGT is pre-designated, and there is only one.

In overview, using a herein-proposed protocol, individual high speed serial channels between the IOC 202 and the DSC 220 may be flexibly bonded to form even faster link bundles. More particularly, channels that originate at the controller MGTs 302 and terminate at the manager MGTs 402, and vice versa, may be flexibly bonded to form high speed link bundles.

Initially, the processor 216 of the DSC 220 may receive an indication of the addition of the IOC 202 to the switching module 102. Such an indication may be received from a Control Services Card (CSC, not shown) within the switching module 102. The CSC detects the insertion of a new IOC over a slow moving bus and interrogates the new IOC to determine the class of traffic carried by the new IOC.

Once the class of the new IOC is determined, the CSC indicates that a new IOC has been connected and also the class of the new IOC. Given the indication of the class (OC48 in the exemplary IOC 202 illustrated FIG. 3) of the IOC 202, the processor 216 determines a number of manager MGTs 402 (two, to continue the example) necessary to provide the indicated class of service. The processor 216 then selects two manager MGTs 402 for an active link bundle and, if a redundant path is to be used, selects two more MGTs 402 for a redundant link bundle. The selected MGTs 402 may then be indicated to the CSC so that the CSC may direct the configuration of the cross point switches 204. Upon receipt of an indication from the CSC that the configuration of the cross point switches 204 is complete, one of the manager MGTs 402 selected for the active link bundle is then configured by the processor to be in MASTER channel bonding mode and the other of the manager MGTs 402 selected for the active link bundle is then configured to be in SLAVE_2_HOPS channel bonding mode. If redundant MGTs have been selected, similar configuration is performed for the selected redundant manager MGTs.

Normally, where the class of an IOC to be connected to a DSC is known, the cross point switches are unnecessary and hardwired traces on a backplane may be used to connect the cards. Advantageously, use of the cross point switches 204 in combination with the dynamic configuration of the MGTs described in full herein allows the attachment of IOCs of arbitrary class to the DSC 220.

The pre-designation of channel bonding mode for MGTs in commercial FPGAs has been found by the applicant to be restrictive. In response, FPGAs in use as the IOC controller 306 and the IOC manager 206 are altered to create a mesh of bonding control ports. Given the freedom of such a mesh, the processor 216 of the DSC 220, according to software exemplifying aspects of the present invention, may arbitrarily and dynamically designate the channel bonding mode of any manager MGT 402 to be MASTER and arrange a connection of the bonding control port of such a dynamically designated MASTER MGT to one or more arbitrary SLAVE MGTs. Furthermore, as will become clear hereinafter, more than one MGT may be designated MASTER, thereby allowing for multiple link bundles.

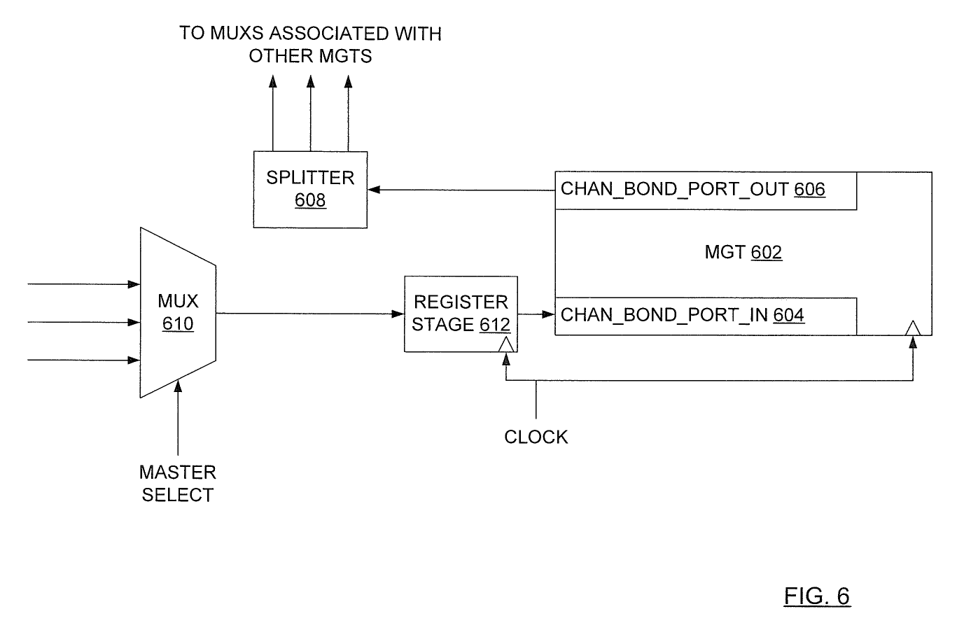

The construction of the mesh of bonding control ports may be implemented in multiple formats. One such format is illustrated in FIG. 6. An MGT 602 has an input bonding control port 604 and an output bonding control port 606, which are labeled CHAN_BOND_PORT_IN and CHAN_BOND_PORT_OUT, respectively. The output bonding control port 606 connects directly to a splitter 608. A multiplexer 610 connects to splitters corresponding to the output bonding control port of every other MGT associated with the FPGA on which the MGT 602 is based. The output of the multiplexer 610, selected among the various inputs according to a MASTER SELECT signal, is passed to a register stage 612, where the timing of the sending of the signal to the input bonding control port 604 of the MGT 602 is controlled by a clock that is also used to provide timing to the MGT 602.

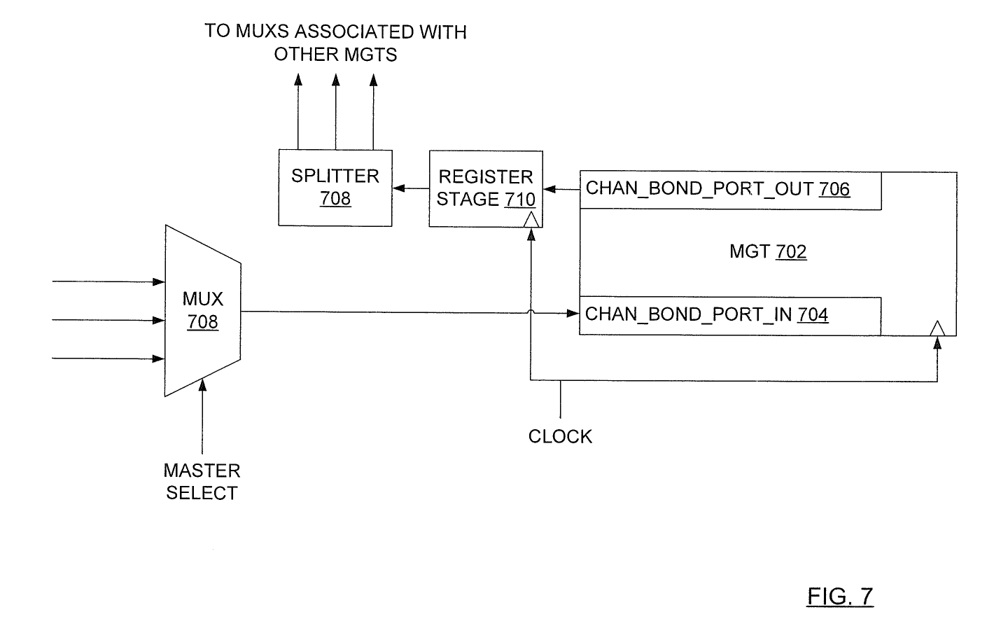

In an alternate format, illustrated in FIG. 7, an MGT 702 has an input bonding control port 704 and an output bonding control port 706, which are labeled CHAN_BOND_PORT_IN and CHAN_BOND_PORT_OUT, respectively. The output bonding control port 706 connects to a splitter 708 via a register stage 712, where the timing of the sending of the output channel bonding signal to splitter 708, and thus to the input bonding control port of another MGT, is controlled by a clock that is also used to provide timing to the MGT 702. A multiplexer 710 connects to splitters corresponding to the output bonding control port of every other MGT associated with the FPGA on which the MGT 702 is based. The output of the multiplexer 710, selected among the various inputs according to a MASTER SELECT signal, is passed directly to the input bonding control port 704 of the MGT 702.

The protocol mentioned hereinbefore may be based upon a PCS superframe wherein control and payload data, respectively, have a predetermined location within a serially transmitted superframe of data. After appropriate configuration of MGTs 302, 402, superframes are transmitted continually from MGT to MGT.

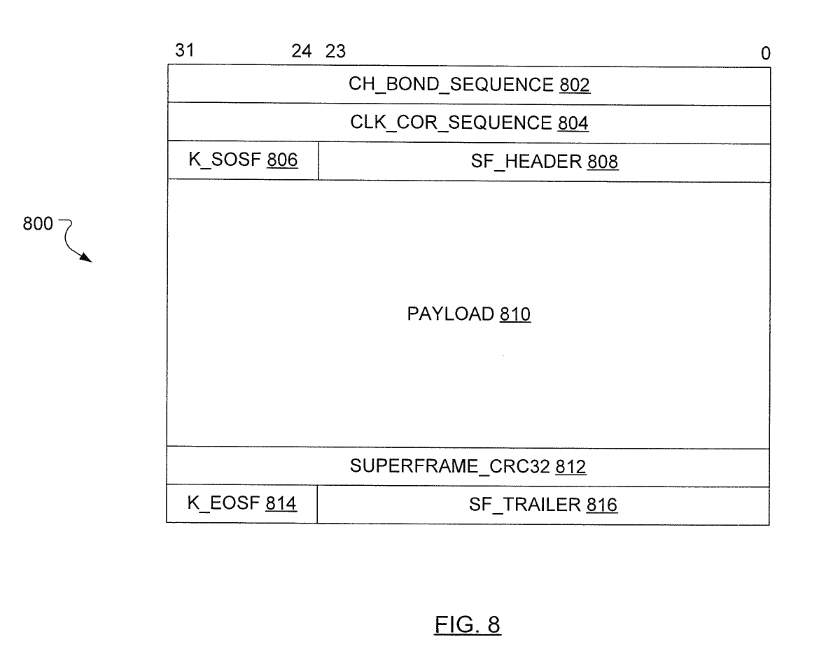

An exemplary such superframe 800 is illustrated in FIG. 8 as having a logical structure that is 4096 by 32 bits. The superframe 800 includes a channel bonding sequence 802, a clock correction sequence 804, a start of superframe (SOSF) indication 806, a superframe header 808, 4091 32-bit words of payload 810 (often link layer data), a cyclic redundancy check (CRC32) word 812, an end of superframe (EOSF) indication 814 and a superframe trailer 816.

Notably, the 32-bit CRC32 word 812 may be automatically inserted into the superframe, although some implementations may require explicit instruction. As the CRC word 812 is a PCS layer function, only the contents of its own PCS superframe are covered (i.e., the superframe CRC word does not necessarily map to any link layer CRC32). Furthermore, the CRC word 812 does not cover the channel bonding sequence 802, the clock correction sequence 804 or the superframe trailer 816. The continual transmission of the superframes is important in CRC32 integrity checking.

If there is no link layer data to be transmitted in a given superframe payload, then a pre-determined “idle” sequence may inserted into transmitted superframes until there is link layer data to be transmitted. The idle sequence is important to assist the definition of byte ordering and byte alignment at the receiving MGT. In particular, consider the MGT 402 of FIG. 5. The deserializer 504 converts a received and buffered data stream (in superframe format) into a ten bit wide parallel stream. Each set of ten bits may be decoded into an appropriate set of eight bits by the decoder 506. However, the output bus from the MGT 402 is 16 bits wide. Additionally, the received superframe may be considered to consist of 16 bit words. It is therefore important that the correct set of eight bit be placed on the 16-bit bus in the appropriate “lanes”, i.e., lanes 0-7 or lanes 8-15. Superframes that carry the idle sequence as payload may be seen to be “commas” in between superframes that carry link layer data or control data.

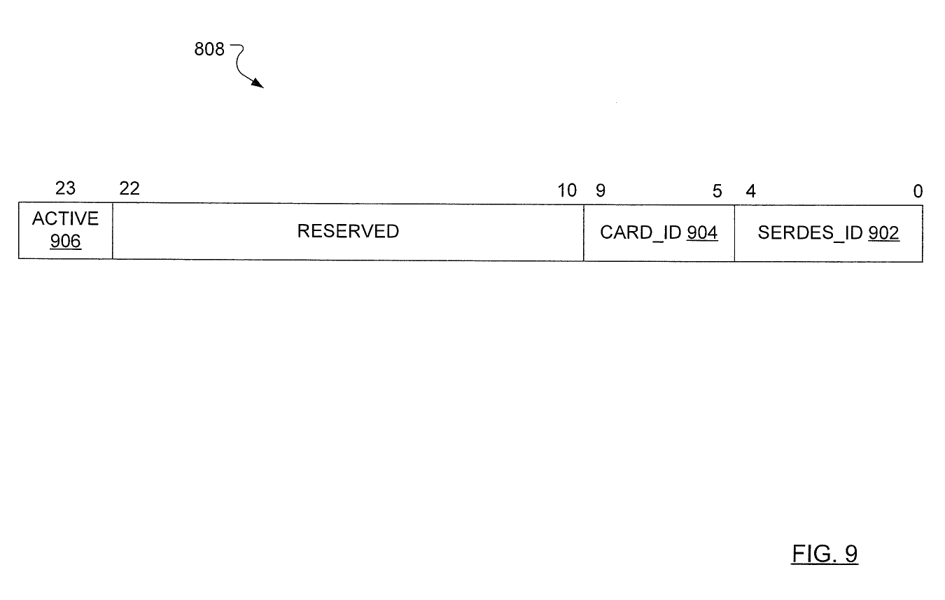

A format for the superframe header 808 is illustrated in FIG. 9. In particular, the superframe header 808 is shown to include a SERDES_ID field 902 for identifying the manager MGT 402 at the IOC manager 206 end of a channel over which the superframe is being sent. Additionally, a CARD_ID field 904 is used for identifying the controller MGT 302 at the IOC controller 306 end of the same channel. Bits 10 through 22 of the 24 bit superframe header are shown to be reserved while bit 23 is shown to be an ACTIVE bit 906 used to indicate that the link bundle of which the superframe is a part is the active link bundle.

As has been alluded to hereinbefore, the IOC manager 206 may have a number of manager MGTs available for connecting to IOCs (see FIG. 10). In contrast, the class of an IOC, and whether or not a redundant path is to be used, essentially dictates the number of controller MGTs to be included on the IOC controller.

In operation, the processor 216 of the DSC 220, given information about a given IOC 202, determines a number of channels that are to be bonded to create a path from the IOC 202 to the DSC 220 and from the DSC 220 to the IOC 202. This initial determination may be made, for example, at the time that controlling software is downloaded for use by the processor 216 or at the time that the IOC 202 is inserted into the switching module 102. Each manager MGT 402 of a subset of manager MGTs 402, having the determined number of manager MGTs 402, is then selected for transmitting and receiving on the determined number of channels. Automatic detection may be used to determine available paths through the cross point switches 204 and available controller MGTs 302 that may be used to connect to the subset of selected manager MGTs 402. Given the automatically detected availability, electrical paths (channels) may be configured through the cross point switches 204 between the controller MGTs 302 and the manager MGTs 402 so that, initially at least, superframes may be exchanged by the MGTs. MGT attributes may also be configured through instructions generated at the processor 216, where the configuration of MGT attributes attempts to optimize the channels using these paths.

According to a Xilinx application note, “Dynamic Reconfiguration of RocketIO MGT Attributes” (hereby incorporated herein by reference), when using MGTs to create high-speed serial links across a backplane, the distance the signals must travel can change significantly. Adjusting the attribute settings for pre-emphasis and/or differential swing control (this is an LVDS characteristic specifying the output voltage swing of the MGT) to compensate for the change in distance allows for a high quality signal transmission at the intended baud rate. These transmit MGT attributes may be configured by the processor 216 in addition to receive MGT attributes such as a receiver equalization attribute, which allows adjustment of the MGT to better track incoming signals.

If the configured channels appear clean (i.e., a number of errors detected is below a pre-set threshold, where errors may be detected through the analysis of the CRC32 word 812), then the processor 216 may proceed to configure the bonding of channels, at the channel bonder 404, to form at least one link bundle, where each link bundle traverses one of the cross point switches 204. Such bonding configuration involves designating the channel bonding mode of a particular manager MGT 402 to be MASTER. A number of further manager MGTs 402, as dictated by the class of the IOC 202, are then designated as being in SLAVE_2_HOPS channel bonding mode.

The manager IP core loaded from the software medium 230 may facilitate implementation of the present invention on FPGAs that do not directly support dynamic allocation of channel bonding mode to MGTs. Similarly, the controller IP core loaded from the software medium 330 may facilitate implementation of the present invention on FPGAs that do not directly support dynamic allocation of channel bonding mode to MGTs.

The channel bonding mode of the controller MGTs 302 of the IOC controller 306 may also be configured by the processor 216.

Once the MGTs have been configured, link layer data may arrive from the line 308 (FIG. 3) and depart to the switching fabric 104 (FIG. 1). Link layer data arriving on one line 308 may be transmitted serially (in superframes) by the receiving IOC 202 on two link bundles, one link bundle through the first cross point switch 204A and one link bundle through the second cross point switch 204B.

To accomplish the redundant path transmission, superframes having the identical payload data to superframes sent by the first controller MGT 302-1 to the first cross point switch 204A may be sent by the third controller MGT 302-3 to the second cross point switch 204B. Similarly, superframes having the identical payload data to superframes sent by the second controller MGT 302-2 to the first cross point switch 204A may be sent by the fourth controller MGT 302-4 to the second cross point switch 204B. Although the payloads of the superframes are identical, encapsulating information (i.e., the header and trailer information) will be different in each superframe. In particular, the superframe header 808 (FIG. 8) of the superframes sent to the first cross point switch 204A may include an indication that the link bundle to which the superframe is related is to be considered the active link bundle (see the ACTIVE bit 906, FIG. 9). Such an indication would then be lacking in superframes sent to the second cross point switch 204B. Additionally, the superframe header 808 of each superframe may indicate the source MGT in the CARD_ID field 904 and the destination MGT in the SERDES_ID field 902 (FIG. 9).

In summary, at a given instant for this OC48 example, four superframes are being transmitted from the IOC 202. A first superframe indicating an active link bundle is transmitted from the first controller MGT 302-1. A second superframe indicating active link bundle is transmitted from the second controller MGT 302-2. A first superframe indicating redundant link bundle is transmitted from the third controller MGT 302-3. A second superframe indicating redundant link bundle is transmitted from the fourth controller MGT 302-4. The active link bundle superframes may be transmitted to the first cross point switch 204A while the redundant link bundle superframes are transmitted to the second cross point switch 204B.

The superframes arrive at the manager MGTs 402 within the IOC manager 206 from the cross point switches 204A, 204B. In particular, the first superframe indicating active link bundle may be received at the first manager MGT 402-1 while the second superframe indicating active link bundle may be received at the second manager MGT 402-2. Additionally, the first superframe indicating redundant link bundle may be received at the third manager MGT 402-3 while the second superframe indicating redundant link bundle may be received at the fourth manager MGT 402-4.

The link layer data in the payload of superframes may be passed from respective manager MGTs 402 to the channel bonder 404 using a parallel protocol specific the manufacturer of the FPGA used to implement the IOC manager 206. Where identical link layer data is transmitted over an active link bundle and a redundant link bundle, the data from both bundles reaches the channel bonder 404 from individual MGTs 402. The channel bonder 404 is provided with a buffer corresponding to each of the MGTs 402 that connect to the channel bonder 404. It is the task of the channel bonder 404 to order the 16-bit sets received from MGTs 402 that are in the same link bundle and assemble the link layer data for transmission to the SCMRP unit 406.

The SCMRP unit 406 buffers the link layer data from each link bundle. Where one link bundle is active and another link bundle is redundant, the SCMRP unit 406 aligns the buffers holding link layer data from the related link bundles. The SCMRP unit 406 performs a selection function based on prior knowledge of which of the cross point switches 204A, 204B is the active cross point switch for this redundant pair of link bundles. The selected link layer data is then passed, according to the SPI-3 protocol, to the in network processor 208. As the buffers are aligned, if it is ever deemed necessary to switch from the link layer data in from the active link bundle to the link layer data from the redundant link bundle, such a switch may be performed hitlessly, that is, without undue overhead and delay often associated with switching from an active stream of data to an redundant stream of data.

Received control data originating at the IOC controller 306 or the IOC manager 206 may be passed to the processor 216 via the processor interface adapter 214, preferably according to a protocol closely related to the SPI-3 (or SPI-4) protocol.

On the egress path, link layer data arrives from the switching fabric 104 (FIG. 1) and departs to the line 308. Link layer data arriving from the switching fabric 104 undergoes egress processing and traffic management at the out network processor 210. The out network processor 210 passes the processed link layer data according to the SPI-3 protocol to the flow control latency unit 212, which acts to clean up some flow control latency issues. This latency-cleansed and processed link layer data is then transmitted according to the SPI-3 protocol to the IOC manager 206.

IOC manager 206 transmits the latency-cleansed and processed link layer data on two paths, one path through the first cross point switch 204A and one path through the second cross point switch 204B. Again, the data may be formatted in superframes according to the herein proposed protocol.

To accomplish the redundant path transmission, superframes having the identical payload data may be sent from the first manager MGT 402-1 to the first cross point switch 204A may be sent by the third manager MGT 402-3 to the second cross point switch 204B. Similarly, superframes having the identical payload data to superframes sent by the second manager MGT 402-2 to the first cross point switch 204A may be sent by the fourth manager MGT 402-4 to the second cross point switch 204B. Although the payloads of the superframes are identical, encapsulating information (i.e., the header and trailer information) will be different in each superframe. In particular, the superframe header 808 (FIG. 8) of the superframes sent to the first cross point switch 204A may include an indication that the link bundle to which the superframe is related is to be considered the active link bundle (see the ACTIVE bit 906, FIG. 9). Such an indication would then be lacking in superframes sent to the second cross point switch 204B. Additionally, the superframe header 808 of each superframe may indicate the source MGT in the SERDES_ID field 902 and the destination MGT in the CARD_ID field 904 (FIG. 9).

In summary, at a given instant for this example, four superframes are being transmitted from the DSC 220. A first superframe indicating active link bundle is transmitted from the first manager MGT 402-1. A second superframe indicating active link bundle is transmitted from the second manager MGT 402-2. A first superframe indicating redundant link bundle is transmitted from the third manager MGT 402-3. A second superframe indicating redundant link bundle is transmitted from the fourth manager MGT 402-4. The active link bundle superframes may be transmitted to the first cross point switch 204A while the redundant link bundle superframes are transmitted to the second cross point switch 204B.

The IOC manager 206 may broadcast the link layer data to two IOCs 202 if port protection is to be employed.

The superframes arrive at the controller MGTs 302 within the IOC controller 306 from the cross point switches 204A, 204B. In particular, the first superframe indicating active link bundle may be received at the first controller MGT 302-1 while the second superframe indicating active link bundle may be received at the second controller MGT 302-2. Additionally, the first superframe indicating redundant link bundle may be received at the third controller MGT 302-3 while the second superframe indicating redundant link bundle may be received at the fourth controller MGT 302-4.

The link layer data in the payload of each superframe may be passed from respective controller MGTs 302 to the SCMCMRP unit 304. The SCMCMRP unit 304 performs a selection function based on prior knowledge of which of the cross point switches 204A, 204B is the active cross point switch for this redundant pair of link bundles. The received link layer data is then passed to the appropriate PHY 312. From the PHY 312, the link layer data is transmitted serially from the corresponding port 310 over the corresponding line 308.

Notably, the SPI-3 protocol specifies an interface between a physical layer device and a link layer device. Where the physical layer device is considered to be the PHY device 312 (FIG. 3) and the link layer devices are considered to be the network processors 208, 210 (FIG. 2), the IOC controller 306 and the IOC manager 206 may be seen to, in combination, act as a bus extension for the SPI-3 interface.

Control data bound for the IOC manager 206 or the IOC controller 306 may arrive at the IOC manager 206 from the processor interface adapter 214. In the event that the control data is bound for the IOC manager 206, the IOC manager 206 performs the requested actions and passes the message back to the processor interface adapter 214.

In the event that the control data is bound for the IOC controller 306, the IOC manager 206 inserts the control data into the payload 810 (FIG. 8) of superframes that are being transmitted to the IOC 202.

Preferably, flow control information from devices attached to the IOC controller 306 and the IOC manager 206 (i.e., the PHY devices 312 and the network processors 208, 210, which may be, generally, referred to as “endpoints”) are conveyed towards one another with minimal latency. Since a high degree of latency over a link bundle cannot be tolerated by the endpoints, a minimal amount of buffering and scheduling is deployed by the IOC manager 206 and the IOC controller 306. The guiding philosophy on this account is that buffers and schedulers are deployed as near as possible to the endpoints for both the ingress and egress paths.

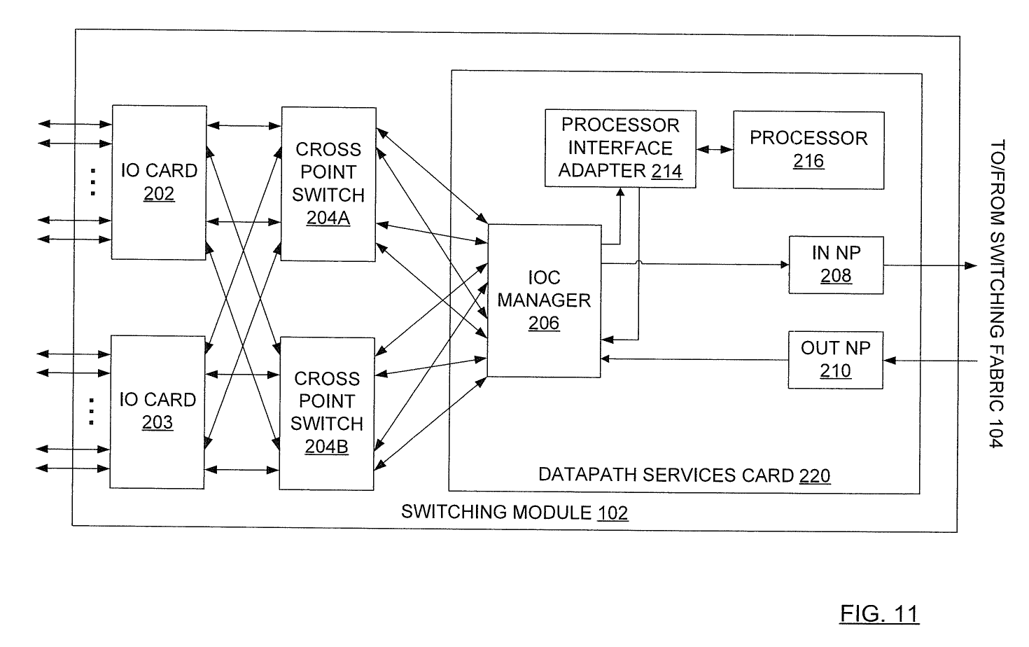

As will be understood by a person skilled in the art, a single IOC manager 206 may serve multiple IOCs 202 through the appropriate configuration of the cross point switches 204. FIG. 11 illustrates the switching module 102 of FIG. 2 with the addition of a second IOC 203. Also notable in FIG. 11 is the elimination of the flow control latency unit 212. it is anticipated that improvements in the network processors used for the out network processor 210 will eliminate a need for the flow control latency unit 212.

The number of MGTs involved in a link bundle is variable. Consider, for example, the 16 transceiver IOC manager 1000 of FIG. 10. Two manager MGTs 1002 may provide an OC12 class link bundle by bonding a single (redundant) 2.5 Gbit/s channel to give a 2.5 Gbit/s link bundle (when 8B10B is used). Four manager MGTs 1002 may provide an OC48 class link bundle by bonding, as discussed hereinbefore, two (redundant) 2.5 Gbit/s channels to give a 5.0 Gbit/s link bundle (when 8B10B coding is used). Ten manager MGTs 1002 may provide an OC192 class link bundle by bonding five (redundant) 2.5 Gbit/s channels to give a 12.5 Gbit/s link bundle (when 8B10B coding is used).

Multiple, and different types of, link bundles may be in place at any given time. Additionally, link bundles may be brought up and torn down on the fly. For instance, an OC12 class link bundle may be initially set up using any two manager MGTs 1002, followed by the setting up of an OC48 class link bundle using another four manager MGTs 1002 and the subsequent setting up of an OC192 class link bundle (using another ten MGTs 1002). The OC48 link bundle may then be torn down (freeing up four MGTs 1002), all while maintaining a working datapath.

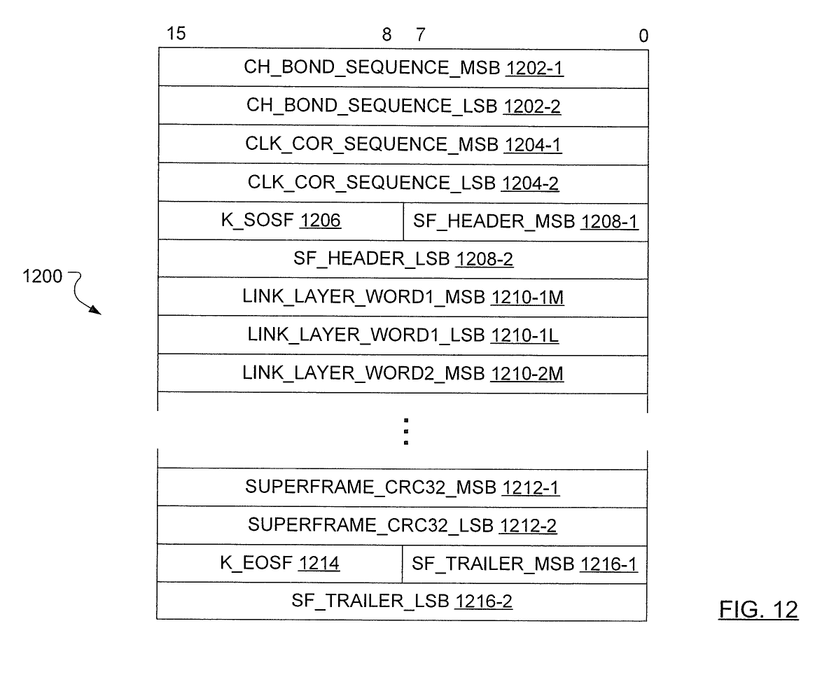

More particularly, superframes for one channel, two channel and multiple channel link bundles are illustrated in FIGS. 12-14.

A single-bonded-channel exemplary superframe 1200 is illustrated in FIG. 12 as having a 16-bit wide structure that maps to the 4096 by 32 bits structure of the exemplary superframe 800 of FIG. 8. The single-bonded-channel exemplary superframe 1200 includes a channel bonding sequence including a most significant bit 1202-1 and a least significant bit 1202-2, a clock correction sequence including a most significant bit 1204-1 and a least significant bit 1204-2, a start of superframe (SOSF) indication 1206, a superframe header including a most significant bit 1208-1 and a least significant bit 1208-2, 16-bit words of payload, a CRC32 word including a most significant bit 1212-1 and a least significant bit 1212-2), an end of superframe (EOSF) indication 1214 and a superframe trailer including a most significant bit 1216-1 and a least significant bit 1216-2.

As the link layer data that is often the payload of the single-bonded-channel exemplary superframe 1200 is typically expressed as 32 bit words, the words are divided for inclusion in the single-bonded-channel exemplary superframe 1200. In particular, a first word is shown divided into a most significant bit 1210-1M and a least significant bit 1210-1L and a most significant bit 1210-2M of a second word is shown.

Notably, the word “bit” is used in this context as synonymous with “portion” rather than the usual “binary digit” context.

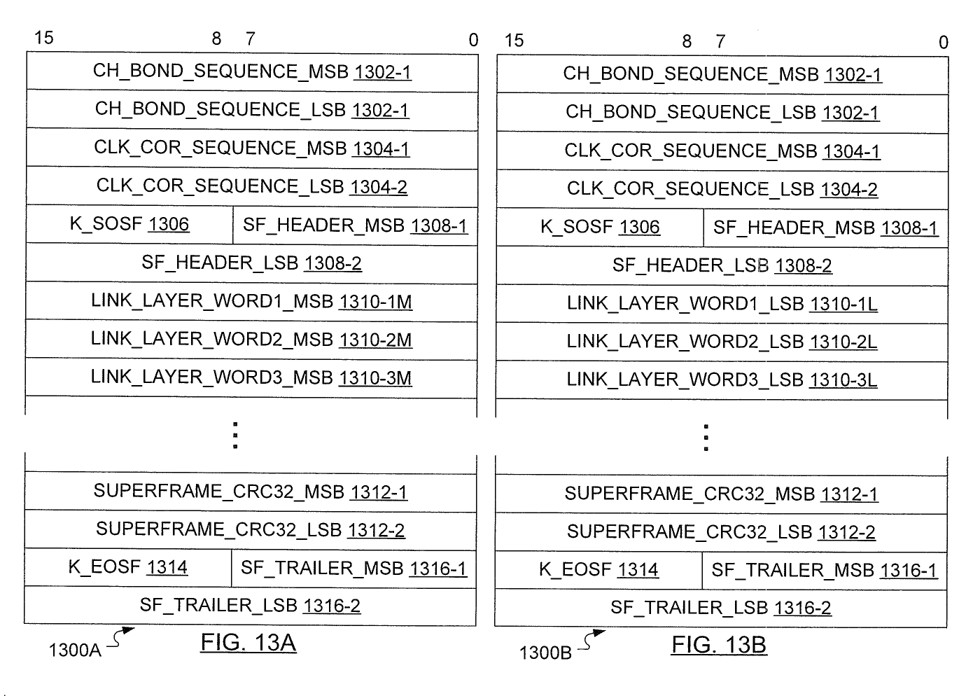

An exemplary superframe is illustrated in each of FIGS. 13A and 13B for use when bonding two channels. In particular, a MASTER superframe 1300A (i.e., a superframe destined for a MASTER MGT) is shown in FIG. 13A and a SLAVE_2_HOPS superframe 1300B (i.e., a superframe destined for a SLAVE_2_HOPS MGT) is illustrated in FIG. 13B. The exemplary superframes 1300A, 1300B share commonly referenced fields including a channel bonding sequence including a most significant bit 1302-1 and a least significant bit 1302-2, a clock correction sequence including a most significant bit 1304-1 and a least significant bit 1304-2, a start of superframe (SOSF) indication 1306, a superframe header including a most significant bit 1308-1 and a least significant bit 1308-2, 16-bit words of payload, a CRC32 word including a most significant bit 1312-1 and a least significant bit 1312-2), an end of superframe (EOSF) indication 1314 and a superframe trailer including a most significant bit 1316-1 and a least significant bit 1316-2.

As the link layer data that is often the payload of the two-bonded-channels exemplary superframes 1300A, 1300B is typically expressed as 32 bit words, the words are divided for inclusion in the exemplary superframes 1300A, 1300B used for bonding two channels. In particular, a first word is shown divided into a most significant bit 1310-1M, transmitted in the MASTER superframe 1300A, and a least significant bit 1310-1L, transmitted in the SLAVE_2_HOPS superframe 1300B. A second word is shown divided into a most significant bit 1310-2M, transmitted in the MASTER superframe 1300A, and a least significant bit 1310-2L, transmitted in the SLAVE_2_HOPS superframe 1300B. A third word is shown divided into a most significant bit 1310-3M, transmitted in the MASTER superframe 1300A, and a least significant bit 1310-3L, transmitted in the SLAVE_2_HOPS superframe 1300B.

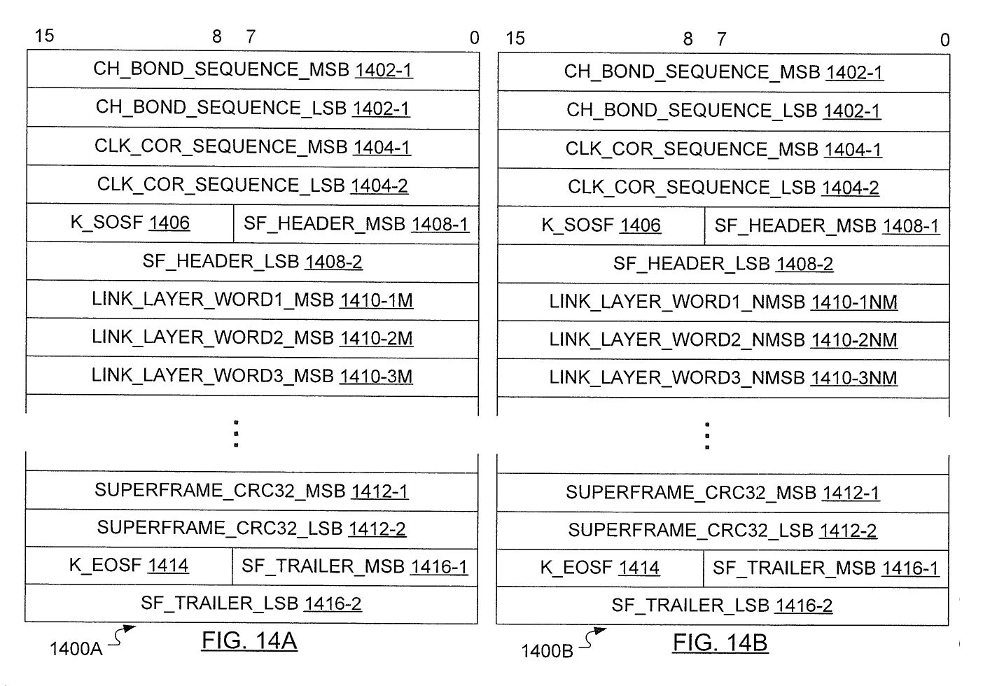

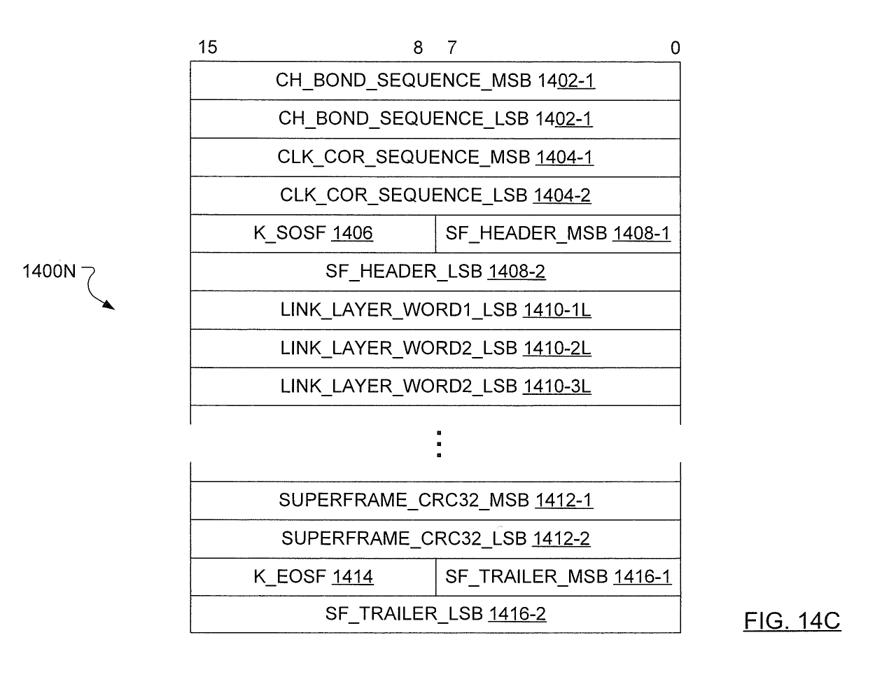

An exemplary superframe is illustrated in each of FIGS. 14A, 14B and 14C for use when bonding N channels. In particular, a MASTER superframe 1400A is shown in FIG. 14A, the next superframe 1400B is illustrated in FIG. 14B and the last superframe 1400N of the N-1 SLAVE_2_HOPS superframes is illustrated in FIG. 14C. The exemplary superframes 1400A, 1400B, 1400N share commonly referenced fields including a channel bonding sequence including a most significant bit 1402-1 and a least significant bit 1402-2, a clock correction sequence including a most significant bit 1404-1 and a least significant bit 1404-2, a start of superframe (SOSF) indication 1406, a superframe header including a most significant bit 1408-1 and a least significant bit 1408-2, 16-bit words of payload, a CRC32 word including a most significant bit 1412-1 and a least significant bit 1412-2), an end of superframe (EOSF) indication 1414 and a superframe trailer including a most significant bit 1416-1 and a least significant bit 1416-2.

As the link layer data that is often the payload of the N-bonded-channel exemplary superframes 1400A, 1400B, 1400N is typically expressed as N×16-bit words, the words are divided for inclusion in the exemplary superframes 1400A, 1400B, 1400N used for bonding N channels. In particular, a first word is shown divided into a most significant bit 1410-1M, transmitted in the MASTER superframe 1400A, a next-most significant bit 1410-1NM, transmitted in the next superframe 1400B and a least significant bit 1410-1L, transmitted in the last superframe 1400N. A second word is shown divided into a most significant bit 1410-2M, transmitted in the MASTER superframe 1400A, a next-most significant bit 1410-2NM, transmitted in the next superframe 1400B and a least significant bit 1410-2L, transmitted in the last superframe 1400N. A third word is shown divided into a most significant bit 1410-3M, transmitted in the MASTER superframe 1400A, a next-most significant bit 1410-3NM, transmitted in the next superframe 1400B and a least significant bit 1410-3L, transmitted in the last superframe 1400N.

The superframe protocol allows independent paths to be realigned after the channel bonder 404. As such, the IOC controller 306 may bond two channels using two controller MGTs 302 for one path and another two controller MGTs 302 for a redundant path. The SCMRP unit 406 takes the two independent streams after the channel bonder 404 and realigns the independent streams. The SCMRP unit 406, according to the configuration of software or hardware, may then hitlessly select between the two independent streams.

Advantageously, clock correction sequences are embedded in the superframes so that the transmitter and receiver (the IOC controller 306 and the IOC manager 206) may be run off independent clock sources.

Notably, the point-to-point CRC32 integrity checking is embedded in the superframes (CRC32 word 812) so that point failures may be detected. That is, a lack of signal integrity between a single manager MGT 402 and a single controller MGT 302 over a given cross point switch may be detected in the form of superframe CRC32 errors. As such, a processor on the IOC manager 206 or IOC controller 306 can diagnose exactly which MGT path has errors, without relying on higher protocol layers. This is especially important when multiple channels are bonded together, in which case higher level protocols are likely to have great difficulty identifying which MGT-to-MGT path is generating errors. Although the link layer data, control data and flow control data may be exchanged over one or more MGTs to move between an IOC controller 306 and an IOC manager 206, a superframe is always exchanged between single MGTs. As such, it has been recognized that the MGT-to-MGT connection is the best place to assess path integrity.

Advantageously, the superframe header includes connection-to-connection ID fields to allow for debugging of connectivity of the cross point switches 204 (FIG. 2).

In summary, the automated detection and selection of a required number of MGTs and the dynamic configuration of attributes (including channel bonding mode) of the selected MGTs allows for the reception of channels and bonding of the channels into link bundles of various sizes. Examples given include the bonding of one, two and five channels to form link bundles. Additionally, multiple link bundles may be formed which allows for the transmission of a redundant link bundle where not possible in known channel bonding implementations. The redundant link bundle, in combination with the superframe format, allows for robust channel bonded communication between the IOC manager 206 and the IOC controller 306 and flexible reconfiguration, responsive to the connection of varied IOCs, of the size of, and channels used by, the channel bonded link bundles. Such flexible reconfiguration of the IOC manager 206 may be responsive to receiving indication, from the CSC, of a disconnection from the switch module 102 of one IOC and receiving indication, again from the CSC, of a connection of another IOC.

Although elements of the DSC 220 and the IOC 202 of switching module 102 (FIG. 2) have been described as FPGAs, it should be apparent to a person skilled in the art that these devices have been selected for speed of integration into a product. It should be appreciated that the functions provided by the various FPGAs may eventually be provided by application specific integrated circuits (ASICs). Advantageously, ASICs provide an opportunity to implement more MGTs in a given device (e.g., 12+12=24 MGTs) than may be implemented in commercially available FPGAs. Further, ASICs may be designed that overcome limitations in commercially available FPGAs, such as the ability to handle OC192 class IOCs. Even further, it should be appreciated that ASICs are generally known to be around 33% more cost effective than FPGAs.

It should also be apparent to a person skilled in the art that the redundant paths over the cross point switches provide additional robustness to the flexible channel bonding described hereinbefore, yet redundant paths are not essential to the implementation of aspects of the present invention.

Other modifications will be apparent to those skilled in the art and, therefore, the invention is defined in the claims.

1.-23. (canceled)

24. At a first communication circuit, a method of handling communication with a second communication circuit, said first communication circuit including a plurality of transceivers, said method comprising:
receiving an indication of a class of service required by said second communication circuit;
determining a number of transceivers necessary to provide said class of service;
selecting said number of transceivers to form a subset of selected transceivers from said plurality of transceivers;
configuring, after selecting said number of transceivers to form a subset of selected transceivers, a channel bonding mode of a given transceiver among said subset of selected transceivers;
receiving serial data at each transceiver of said subset of selected transceivers; and
aggregating said serial data at each transceiver of said subset of selected transceivers into an aggregate channel.

25. The method of claim 24 wherein said channel bonding mode designates said given transceiver as master, said master transceiver for aligning data received by said subset of selected transceivers.

26. The method of claim 24 further comprising, responsive to receiving indication of a disconnection of said second communication circuit and a connection of a third communication circuit, reconfiguring said attribute of said given transceiver.

27. The method of claim 24 wherein transceivers in said first subset of transceivers are connected to said second communications circuit via a first cross point switch and said method further comprises transmitting an indication of said first subset to facilitate a configuration of said first cross point switch.

28. The method of claim 24 wherein said subset of selected transceivers is a first subset of selected transceivers and said method further comprises:
selecting said number of transceivers to form a second subset of selected transceivers from said plurality of transceivers; and
configuring a given transceiver among said second subset of selected transceivers as a master transceiver for aligning data received by said second subset of selected transceivers.

29. The method of claim 28 wherein transceivers in said second subset of transceivers are connected to said second communications circuit via a second cross point switch and said method further comprises transmitting an indication of said second subset to facilitate a configuration of said second cross point switch.

30. The method of claim 28 further comprising:
buffering an output of each transceiver in said first subset of transceivers;
buffering an output of each transceiver in said second subset of transceivers; and
selecting said aggregate channel for further transmission.

31. The method of claim 30 further comprising:
detecting errors in said aggregate channel; and
selecting said output of each transceiver in said second subset of transceivers for further transmission.

32. The method of claim 24 wherein said class of service is one of SONET OC12, SONET OC48 or SONET OC192.

33. The method of claim 24 wherein said configuring said attribute comprises altering an electrical characteristic of transmission at said given transceiver.

34. The method of claim 33 wherein said electrical characteristic of transmission is pre-emphasis.

35. The method of claim 33 wherein said electrical characteristic of transmission is differential swing control.

36. The method of claim 24 wherein said configuring said attribute comprises altering an electrical characteristic of reception at said given transceiver.

37. The method of claim 36 wherein said electrical characteristic of reception is receiver equalization.

38. A first communications circuit comprising:
a plurality of transceivers;
a processor adapted to:
receive an indication of a class of service required by a second communication circuit to be connected to said first communication circuit;
determine a number of transceivers necessary to provide said class of service;
select said number of transceivers to form a subset of selected transceivers from said plurality of transceivers;
configure, after selecting said number of transceivers to form a subset of selected transceivers, a channel bonding mode of a given transceiver among said subset of selected transceivers; and
a channel bonder for aggregating serial data received at each transceiver of said subset of selected transceivers into an aggregate channel.

39. The first communications circuit of claim 38 wherein said plurality of transceivers is connected to said second communication circuit by SERDES channels.

40. The first communications circuit of claim 39 where said SERDES channels connect said plurality of transceivers to said second communication circuit via a cross point switch and said processor is further adapted to configure said cross point switch.

41. The first communications circuit of claim 38 wherein said processor, in being adapted to configure a channel bonding mode of a given transceiver, is adapted to designate said given transceiver as a master transceiver, said master transceiver for aligning data received by said subset of selected transceivers.

42. A computer readable medium containing processor-executable instructions which, when performed by a processor in a first communications circuit that includes a plurality of transceivers, cause the processor to:
receive an indication of a class of service required by a second communication circuit to be connected to said first communication circuit;
determine a number of transceivers necessary to provide said class of service;
select said number of transceivers to form a subset of selected transceivers from said plurality of transceivers;
configure, after selecting said number of transceivers to form a subset of selected transceivers, a channel bonding mode of a given transceiver among said subset of selected transceivers; and
communicate an indication of said subset of selected transceivers such that a channel bonder aggregates serial data received at each transceiver of said subset of selected transceivers into an aggregate channel.

43. The computer readable medium of claim 42 wherein said computer executable instructions that cause said processor to configure a channel bonding mode of a given transceiver, cause said processor to designate said given transceiver as a master transceiver which will align data received by said subset of selected transceivers.
